(19) United States
(12) Patent Application Publication
(10) Pub. No.: US 2025/0116761 A1
(43) Pub. Date: Apr. 10, 2025

(54) OPTICAL DEPTH SENSING APPARATUS

(71) Applicant: GUANGZHOU LUXVISIONS INNOVATION TECHNOLOGY LIMITED, GUANGZHOU (CN)

(72) Inventors: Tzu-Yao Lin, GUANGZHOU (CN); Shih-Chieh Yen, GUANGZHOU (CN)

(73) Assignee: GUANGZHOU LUXVISIONS INNOVATION TECHNOLOGY LIMITED, GUANGZHOU (CN)

(21) Appl. No.: 18/792,573

(22) Filed: Aug. 2, 2024

(30) Foreign Application Priority Data
Oct. 8, 2023 (CN) 202311293083.3

(51) Int. Cl. G01S 7/481; G01B 11/22; G01S 7/499; G01S 17/32; G02B 1/00

(52) U.S. Cl. CPC G01S 7/4816; G01B 11/22; G01S 7/499; G01S 17/32; G02B 1/002

(57) ABSTRACT

An optical depth sensing apparatus includes a first light source emitting a first light beam having a first polarization state, a second light source emitting a second light beam having a second polarization state, a first sensing device sensing the first light beam and including a first metalens, and a second sensing device sensing the second light beam and including a second metalens. An electric field direction of the first polarization state is perpendicular to an electric field direction of the second polarization state. The first light beam having the first polarization state is transmitted to the first metalens, and the second light beam having the second polarization state is reflected or absorbed by the first metalens. The second light beam having the second polarization state is transmitted to the second metalens, and the first light beam having the first polarization state is reflected or absorbed by the second metalens.

### CROSS-REFERENCE TO RELATED APPLICATION

This application claims the priority benefit of China application serial no. 202311293083.3, filed on Oct. 8, 2023. The entirety of the above-mentioned patent application is hereby incorporated by reference herein and made a part of this specification.

### BACKGROUND

### Technical Field

The disclosure relates to an optical apparatus, and in particular, relates to an optical depth sensing apparatus.

### Description of Related Art

The principle of time-of-flight (ToF) depth sensing is to measure the total time required for light to propagate from the light source to the surface of the target to be measured, be reflected by the surface, and then enter the sensing device, so as to calculate the distance to the target to be measured. It may be applied in functions including depth sensing, identification, and obstacle avoidance. In some application fields, in order to simultaneously complete at least two of the abovementioned functions, a plurality of light sources and a plurality of sensing devices are required to be used simultaneously. However, in such an apparatus, there may be situations where multiple sensing devices interfere with each other. Therefore, by alternating the light-emitting time of different light sources through time sharing (i.e., reducing the frame rate), different sensing devices are prevented from interfering with each other. However, the above method of reducing the frame rate increases the measurement time and reduces the accuracy of the depth sensing apparatus.

### SUMMARY

The disclosure provides an optical depth sensing apparatus capable of allowing a plurality of sensing devices to perform measuring at the same time without reducing a frame rate and allowing the sensing devices to perform measuring independently without interfering with each other.

An embodiment of the disclosure provides an optical depth sensing apparatus including a first light source, a second light source, a first sensing device, and a second sensing device. The first light source is configured to emit a first light beam having a first polarization state. The second source is configured to emit a second light beam having a second polarization state. An electric field direction of the first polarization state is perpendicular to an electric field direction of the second polarization state. The first sensing device is configured to sense the first light beam and includes a first metalens. The second sensing device is configured to sense the second light beam and includes a second metalens. The first light beam having the first polarization state is transmitted to the first metalens, and the second light beam having the second polarization state is reflected or absorbed by the first metalens. The second light beam having the second polarization state is transmitted to the second metalens, and the first light beam having the first polarization state is reflected or absorbed by the second metalens.

To sum up, in the optical depth sensing apparatus provided by the embodiments of the disclosure, different metalenses transmit light with different polarization states, so that different sensing devices have measurement selectivity for light with different polarization states. The sensing devices can measure independently at the same time without interfering with each other.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an optical depth sensing apparatus according to an embodiment of the disclosure.

FIG. 2A is a schematic diagram of a first sensing device and a second sensing device according to an embodiment of the disclosure.

FIG. 2B illustrates a schematic graph of field curvature of a first sensing device and a second sensing device in this embodiment.

FIG. 2C illustrates a schematic graph of distortion of the first sensing device and the second sensing device in this embodiment.

FIG. 2D illustrates MTF curves of the first sensing device and the second sensing device in this embodiment.

FIG. 2E is an MTF curve of a sensing device according to a comparative example.

FIG. 3A is a schematic diagram of a first sensing device and a second sensing device according to an embodiment of the disclosure.

FIG. 3B illustrates a schematic graph of field curvature of a first sensing device and a second sensing device in this embodiment.

FIG. 3C illustrates a schematic graph of distortion of the first sensing device and the second sensing device in this embodiment.

FIG. 3D illustrates MTF curves of the first sensing device and the second sensing device in this embodiment.

FIG. 4A and FIG. 4B are schematic diagrams of portions of metalenses according an embodiment of the disclosure.

FIG. 4C is a schematic graph of phase delays of the metalenses according to an embodiment of the disclosure.

FIG. 4D is a graph showing a relationship between a nanostructure size and the phase delay according to an embodiment of the disclosure.

### DESCRIPTION OF THE EMBODIMENTS

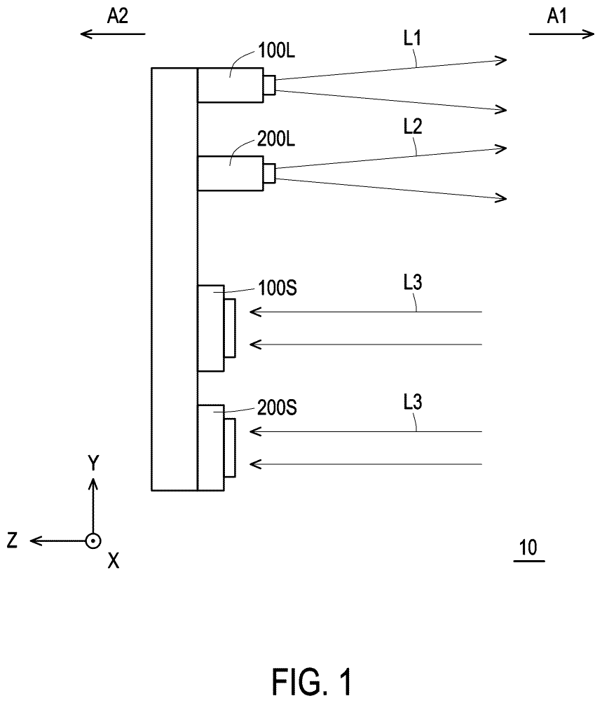

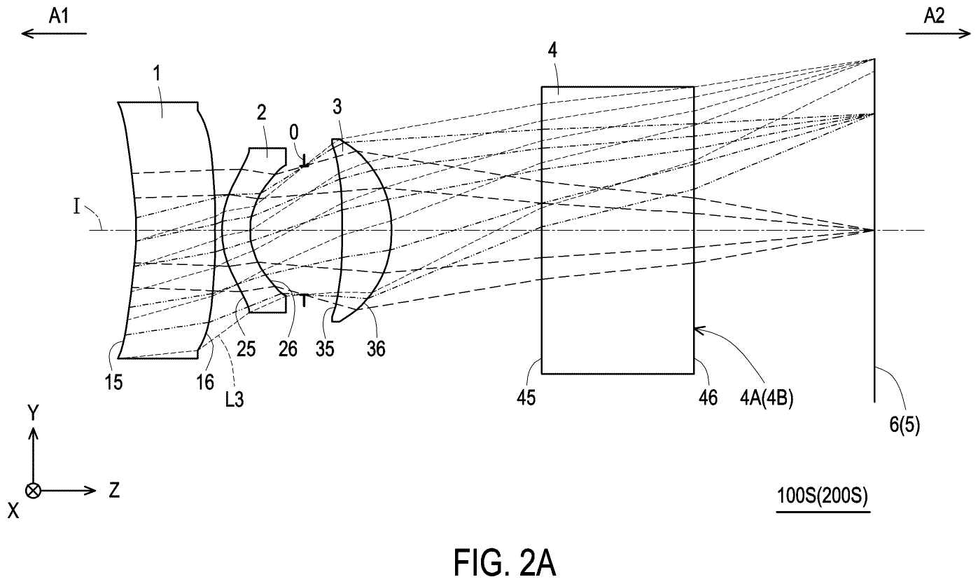

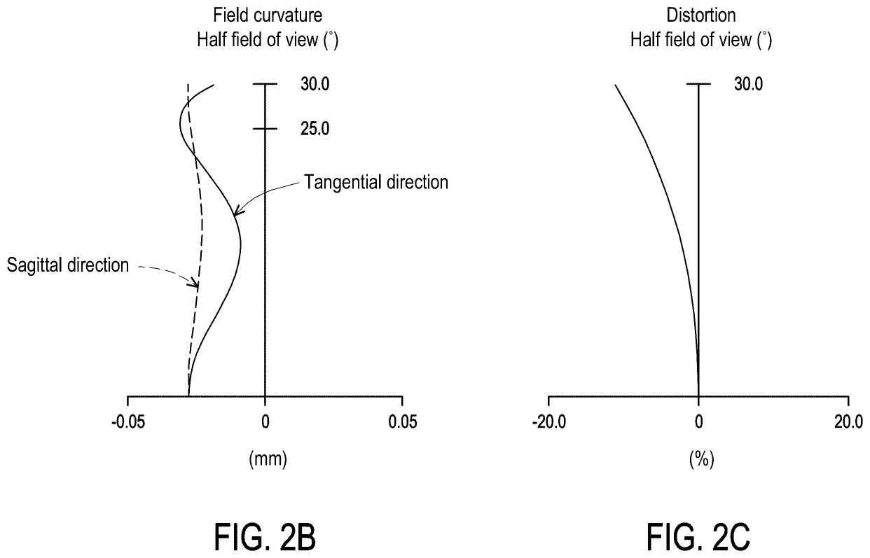

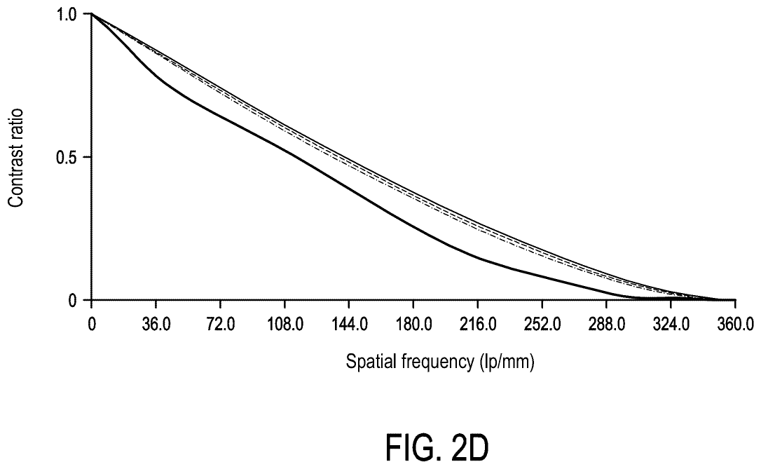

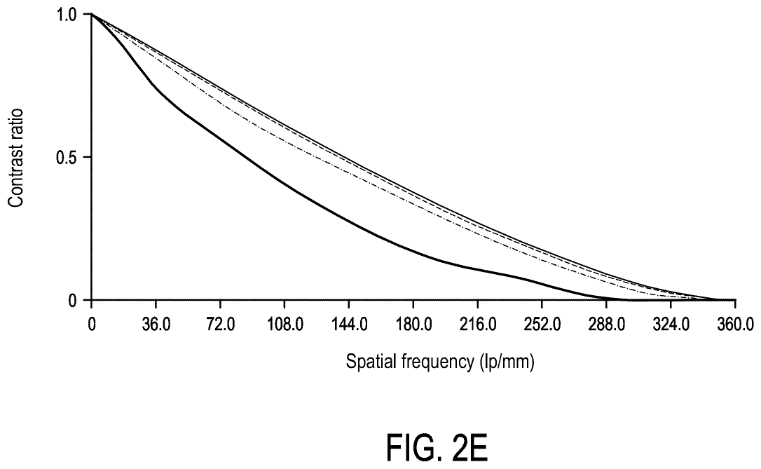

With reference to FIG. 1 and FIG. 2A, according to an embodiment of the disclosure, an optical depth sensing apparatus 10 including a first light source 100L, a second light source 200L, a first sensing device 100S, and a second sensing device 200S is provided. The first light source 100L is configured to emit a first light beam L1 having a first polarization state P1. The second source 200L is configured to emit a second light beam L2 having a second polarization state P2. An electric field direction of the first polarization state P1 is perpendicular to an electric field direction of the second polarization state P2, for example, the first light beam L1 is s light and the second light beam L2 is p light. After the first light beam L1 and the second light beam L2 are reflected by a target to be measured, reflected light L3 is formed. That is, the reflected light L3 includes the first light beam L1 and the second light beam L2.

In this embodiment, the first sensing device 100S and the second sensing device 200S are provided separately and include the same optical elements and the same configuration. To be specific, the first sensing device 100S and the second sensing device 200S each include in sequence a first lens 1, a second lens 2, a third lens 3, a transparent substrate 4, and a sensing element 5 (not shown) along an optical axis I from an object side A1 to an image side A2, where the sensing element 5 includes an imaging surface 6. An aperture 0 is located between the second lens 2 and the third lens 3, as shown in FIG. 2A.

The difference between the first sensing device 100S and the second sensing device 200S is that the first sensing device 100S further includes a metalens 4A disposed on an image-side surface 46 of its transparent substrate 4 close to the imaging surface 6, and the second sensing device 200S further includes a metalens 4B disposed on the image-side surface 46 of its transparent substrate 4 close to the imaging surface 6. Herein, the first light beam L1 having the first polarization state P1 may be transmitted to the metalens 4A, and the second light beam L2 having the second polarization state P2 may be reflected or absorbed by the metalens 4A. The second light beam L2 having the second polarization state P2 may be transmitted to the metalens 4B, and the first light beam L1 having the first polarization state P1 may be reflected or absorbed by the metalens 4B.

Therefore, the first light beam L1 in the reflected light L3 may be transmitted to the metalens 4A of the first sensing device 100S and reach the imaging surface 6 of the first sensing device 100S. In other words, the first sensing device 100S is configured to sense the first light beam L1 reflecting off the target to be measured. On the other hand, the second light beam L2 in the reflected light L3 may be transmitted to the metalens 4B of the second sensing device 200S and reach the imaging surface 6 of the second sensing device 200S. In other words, the second sensing device 200S is configured to sense the second light beam L2 reflecting off the target to be measured.

In the first sensing device 100S, the first lens 1 has negative diopter, the second lens 2 has negative diopter, the third lens 3 has positive diopter, the transparent substrate 4 has no diopter, and the metalens 4A has negative diopter. Further, the first lens 1, the second lens 2, and the third lens 3 are aspheric lenses. The reflected light L3 entering the first sensing device 100S may be transmitted to the first lens 1, the second lens 2, the aperture 0, the third lens 3, and the transparent substrate 4 in sequence before being filtered by the metalens 4A. The light having the first polarization state P1 reaches the imaging surface 6 of the first sensing device 100S and forms an image on the imaging surface 6.

In the second sensing device 200S, the first lens 1 has negative diopter, the second lens 2 has negative diopter, the third lens 3 has positive diopter, the transparent substrate 4 has no diopter, and the metalens 4B has negative diopter. Further, the first lens 1, the second lens 2, and the third lens 3 are aspheric lenses. The reflected light L3 entering the second sensing device 200S may be transmitted to the first lens 1, the second lens 2, the aperture 0, the third lens 3, and the transparent substrate 4 in sequence before being filtered by the metalens 4B. The light having the second polarization state P2 reaches the imaging surface 6 of the second sensing device 200S and forms an image on the imaging surface 6.

In this embodiment, in each of the first sensing device 100S and the second sensing device 200S, the first lens 1, the second lens 2, the third lens 3, and the transparent substrate 4 each have object-side surfaces 15, 25, 35, and 45 facing the object side A1 and allowing an imaging light to pass through and image-side surfaces 16, 26, 36, and 46 facing the image side A2 and allowing the imaging light to pass through. An optical axis region of the object-side surface 15 of the first lens 1 is a concave surface, and an optical axis region of the image-side surface 16 is a convex surface. An optical axis region of the object-side surface 25 of the second lens 2 is a convex surface, and an optical axis region of the image-side surface 26 is a concave surface. An optical axis region of the object-side surface 35 of the third lens 3 is a concave surface, and an optical axis region of the image-side surface 36 is a convex surface. The object-side surface 45 of the transparent substrate 4 is a flat surface, and the image-side surface 46 is a flat surface.

Phase coefficient parameters (binary coefficients) of the metalens 4A and the metalens 4B are shown in Table One, and the detailed optical data of other elements are shown in Table Two. A field of view (FOV) of the first sensing device and a field of view of the second sensing device fall within a range of 50 degrees to 70 degrees. The first sensing device 100S and the second sensing device 200S satisfy conditional expressions of 3.82<TTL/ImgH<7.2 and 2.4 mm<TTL<2.5 mm, where TTL is a distance on the optical axis I from the object-side surface 15 of the first lens 1 to the imaging surface 6, and ImgH is half of a diagonal of the imaging surface 6. Aperture values (F number) of the first sensing device 100S and the second sensing device 200S are both 2.8.

TABLE ONE

| Wavelength | Maximum | | | | |
|---|---|---|---|---|---|
| (nm) | value | p² | p⁴ | p⁶ | p⁸ |
| 940 | 4 | 3.59E+00 | 7.00E+05 | −3.36E+08 | 2.73E+10 |

TABLE TWO

| | | Radius of | |
|---|---|---|---|
| | | Curvature | Spacing |
| Element | Surface | (mm) | (mm) |
| first lens 1 | object-side | −2.57E+00 | 2.63E−01 |
| | surface 15 | | |
| | image-side | −1.55E+00 | 2.14E−02 |
| | surface 16 | | |
| second lens 2 | object-side | 3.62E−01 | 9.29E−02 |
| | surface 25 | | |
| | image-side | 2.82E−01 | 1.79E−01 |
| | surface 26 | | |
| aperture 0 | | infinity | 1.27E−01 |
| third lens 3 | object-side | −1.01E+00 | 1.63E−01 |
| | surface 35 | | |
| | image-side | −3.91E−01 | 5.00E−01 |
| | surface 36 | | |
| transparent | object-side | infinity | 5.02E−01 |
| substrate 4 | surface 45 | | |
| metalens 4A (4B) | | infinity | 6.00E−01 |
| sensing element 5 | imaging | infinity | 0.00E+00 |
| | surface 6 | | |

In Table Two, a spacing (e.g., 2.63E−01 shown in Table Two) between the object-side surfaces 15 is a thickness of the first lens 1 on the optical axis I, and a spacing (e.g., 2.14E−02 mm shown in Table Two) between the image-side surfaces 16 is a distance between the image-side surface 16 of the first lens 1 and the object-side surface 25 of the second lens 2 on the optical axis I. That is, a gap between the first lens 1 and the second lens 2 on the optical axis I, and the rest may be deduced by analogy.

In this embodiment, the object-side surfaces 15, 25, and 35 and the image-side surfaces 16, 26, and 36 of the first lens 1, the second lens 2, and the third lens 3 are all aspheric surfaces, and these aspheric surfaces are defined according to the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i} \qquad ( 1 )$$

Y: a distance between a point on an aspheric curve and the optical axis,
Z: an aspheric depth, that is, a vertical distance between a point on the aspheric surface that is Y from the optical axis and a tangent plane tangent to a vertex on the optical axis of the aspheric surface,
R: a radius of curvature of a lens surface,
K: a conic constant, and
a₂ᵢ: a 2i^{th} order aspheric coefficient.

In this embodiment, the cone coefficient K in formula (1) and various aspheric surface coefficients on the abovementioned aspheric surface are shown in Table Three. Herein, the number 15 in Table Three indicates that it is the aspheric coefficient of the object-side surface 15 of the first lens 1, and the other numbers may be deduced by analogy.

TABLE THREE

| Surface | K | a₂ | a₄ | a₆ | a₈ |
|---|---|---|---|---|---|
| 15 | 0 | −2.83E−01 | 2.36E+00 | −1.13E+01 | 3.21E+01 |
| 16 | 0 | 5.65E−02 | 1.18E+00 | −1.80E+00 | −6.72E+01 |
| 25 | 0 | 3.38E−01 | −5.32E+00 | −1.91E+01 | −1.23E+03 |
| 26 | 0 | 5.51E−01 | −3.26E+00 | 4.10E+01 | −5.96E+03 |
| 35 | 0 | 2.58E−01 | −2.10E+00 | 1.96E+01 | |
| 36 | 0 | −8.48E−02 | −8.37E−01 | −1.47E+01 | |

| Surface | a₁₀ | a₁₂ | a₁₄ | a₁₆ |
|---|---|---|---|---|
| 15 | 6.72E+00 | −5.17E+02 | 0.00E+00 | 0.00E+00 |
| 16 | −3.36E+02 | 2.31E+03 | 0.00E+00 | 0.00E+00 |
| 25 | 1.63E+04 | −1.20E+05 | 0.00E+00 | 0.00E+00 |
| 26 | 1.25E+05 | −7.62E+05 | 0.00E+00 | 0.00E+00 |
| 35 | 3.13E+03 | 7.72E+02 | −3.58E+05 | 2.27E+06 |
| 36 | −5.14E+03 | 2.96E+03 | 6.60E+05 | −5.49E+06 |

With reference to FIG. 2B to FIG. 2D, FIG. 2B illustrates a schematic graph of field curvature of a first sensing device 100S and a second sensing device 200S in this embodiment. FIG. 2C illustrates a schematic graph of distortion of the first sensing device 100S and the second sensing device 200S in this embodiment. FIG. 2D illustrates MTF curves of the first sensing device 100S and the second sensing device 200S in this embodiment.

As shown in FIG. 2B, when light with a wavelength of 940 nm is incident on the first sensing device 100S and the second sensing device 200S, the field curvature at different fields of view falls within the range of ±0.04 mm. The distortion aberration graph of FIG. 2C shows that the distortion aberration of the first sensing device 100S and the second sensing device 200S is maintained within the range of ±12%. As shown in FIG. 2D, when a spatial frequency is 36 lp/mm, its MTF is still greater than 0.75. With MTF above 30%, a resolution is 160 lp/mm.

With reference to FIG. 2E, which illustrates an MTF curve of a sensing device according to a comparative example. Compared to the first sensing device 100S and the second sensing device 200S, this sensing device is different in that it does not have the metalens 4A or the metalens 4B. In this comparative example, as shown in FIG. 2E, when the spatial frequency is 36 lp/mm, its MTF is still greater than 0.75. However, with MTF above 30%, the resolution is only 130 lp/mm. In other words, through the configuration of the metalens 4A and the metalens 4B, the first sensing device 100S and the second sensing device 200S in the embodiment shown in FIG. 2A achieve the abovementioned polarization selectivity, and the imaging quality is also improved.

In the embodiments of the disclosure, the optical depth sensing apparatus 10 measures the total time required for the first light beam L1 to propagate from the first light source 100L to a surface of the target to be measured, be reflected by the surface, and then enter the first sensing device 100S, so as to calculate a distance to the target to be measured. It may be applied in one of the functions including depth sensing, identification, and obstacle avoidance. Further, the total time required for the second light beam L2 to propagate from the second light source 200L to the surface of the target to be measured, be reflected by the surface, and then enter the second sensing device 200S is measured, so as to calculate the distance to the target to be measured. It may be applied in another one of the functions including depth sensing, identification, and obstacle avoidance.

In order to fully explain various embodiments of the disclosure, other embodiments of the disclosure are described below. It should be noted that the reference numerals and part of the content in the previous embodiment are used in the following embodiments, in which identical reference numerals indicate identical or similar elements, and repeated description of the same technical content is omitted. Please refer to the description of the previous embodiments for the omitted content, which is not repeated hereinafter.

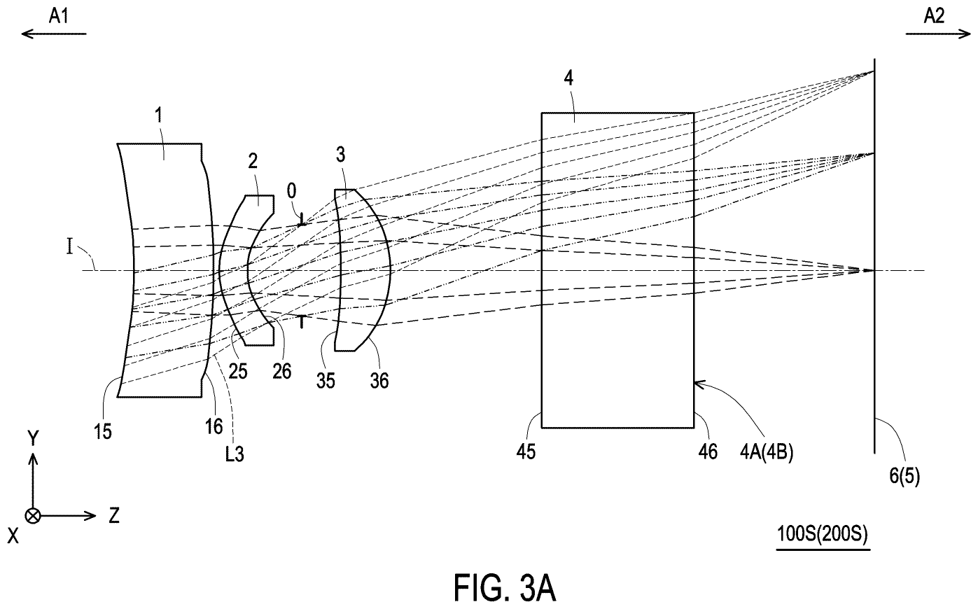

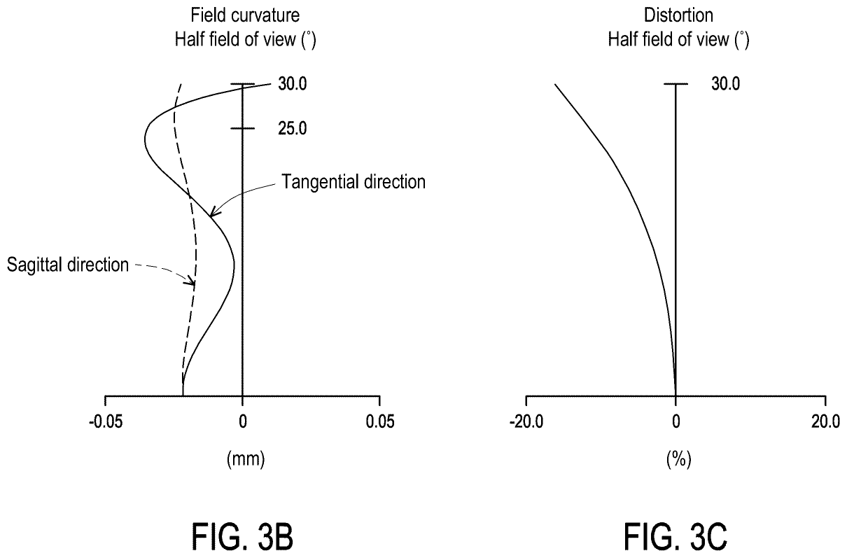

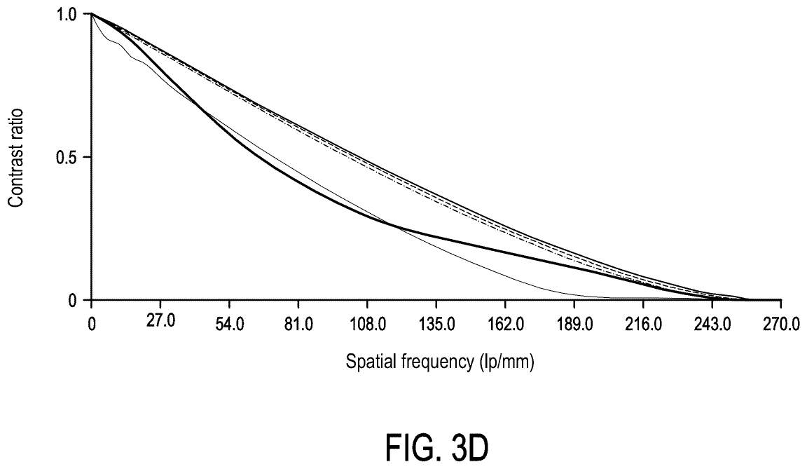

With reference to FIG. 1 and FIG. 3A, according to an embodiment of the disclosure, an optical depth sensing apparatus 10 including a first light source 100L, a second light source 200L, a first sensing device 100S, and a second sensing device 200S is provided. The first light source 100L is configured to emit a first light beam L1 having a first polarization state P1. The second source 200L is configured to emit a second light beam L2 having a second polarization state P2. An electric field direction of the first polarization state P1 is perpendicular to an electric field direction of the second polarization state P2.

In the first sensing device 100S, the first lens 1 has negative diopter, the second lens 2 has negative diopter, the third lens 3 has positive diopter, the transparent substrate 4 has no diopter, and the metalens 4A has negative diopter. Further, the first lens 1, the second lens 2, and the third lens 3 are aspheric lenses.

In the second sensing device 200S, the first lens 1 has negative diopter, the second lens 2 has negative diopter, the third lens 3 has positive diopter, the transparent substrate 4 has no diopter, and the metalens 4B has negative diopter. Further, the first lens 1, the second lens 2, and the third lens 3 are aspheric lenses.

The first sensing device 100S and the second sensing device 200S of this embodiment are the same as those provided in the embodiments shown in FIG. 2A in that the configuration order of the optical elements is the same, so description thereof is not repeated herein.

In this embodiment, in each of the first sensing device 100S and the second sensing device 200S, the first lens 1, the second lens 2, the third lens 3, and the transparent substrate 4 each have object-side surfaces 15, 25, 35, and 45 facing the object side A1 and allowing an imaging light to pass through and image-side surfaces 16, 26, 36, and 46 facing the image side A2 and allowing the imaging light to pass through. An optical axis region of the object-side surface 15 of the first lens 1 is a concave surface, and an optical axis region of the image-side surface 16 is a convex surface. An optical axis region of the object-side surface 25 of the second lens 2 is a convex surface, and an optical axis region of the image-side surface 26 is a concave surface. An optical axis region of the object-side surface 35 of the third lens 3 is a concave surface, and an optical axis region of the image-side surface 36 is a convex surface. The object-side surface 45 of the transparent substrate 4 is a flat surface, and the image-side surface 46 is a flat surface.

The first sensing device 100S and the second sensing device 200S of this embodiment are different from those in the embodiments shown in FIG. 2A in the characteristics and configuration of the optical elements. To be specific, phase coefficient parameters (binary coefficients) of the metalens 4A and the metalens 4B are shown in Table One, and the detailed optical data of other elements are shown in Table Four. A field of view (FOV) of the first sensing device and a field of view of the second sensing device fall within a range of 50 degrees to 70 degrees. The first sensing device 100S and the second sensing device 200S satisfy conditional expressions of 3.82<TTL/ImgH<7.2 and 2.4 mm<TTL<2.5 mm, where TTL is a distance on the optical axis I from the object-side surface 15 of the first lens 1 to the imaging surface 6, and ImgH is half of a diagonal of the imaging surface 6. Aperture values (F number) of the first sensing device 100S and the second sensing device 200S are both 4.

TABLE FOUR

| | | Radius of | |
|---|---|---|---|
| | | Curvature | Spacing |
| Element | Surface | (mm) | (mm) |
| first lens 1 | object-side | −2.60E+00 | 2.60E−01 |
| | surface 15 | | |
| | image-side | −1.56E+00 | 1.92E−02 |
| | surface 16 | | |
| second lens 2 | object-side | 3.61E−01 | 9.18E−02 |
| | surface 25 | | |
| | image-side | 2.81E−01 | 1.79E−01 |
| | surface 26 | | |
| aperture 0 | | infinity | 1.27E−01 |
| third lens 3 | object-side | −1.01E+00 | 1.63E−01 |
| | surface 35 | | |
| | image-side | −3.92E−01 | 4.97E−01 |
| | surface 36 | | |
| transparent | object-side | infinity | 4.97E−01 |
| substrate 4 | surface 45 | | |
| metalens 4A (4B) | | infinity | 6.00E−01 |
| sensing element 5 | imaging | infinity | 0.00E+00 |
| | surface 6 | | |

In this embodiment, the cone coefficient K in formula (1) and various aspheric surface coefficients on the abovementioned aspheric surface are shown in Table Five. Herein, the number 15 in Table Five indicates that it is the aspheric coefficient of the object-side surface 15 of the first lens 1, and the other numbers may be deduced by analogy.

TABLE FIVE

| Surface | K | a₂ | a₄ | a₆ | a₈ |
|---|---|---|---|---|---|
| 15 | 0 | −2.83E−01 | 2.36E+00 | −1.13E+01 | 3.21E+01 |
| 16 | 0 | 5.65E−02 | 1.18E+00 | −1.80E+00 | −6.72E+01 |
| 25 | 0 | 3.38E−01 | −5.32E+00 | −1.91E+01 | −1.23E+03 |
| 26 | 0 | 5.51E−01 | −3.26E+00 | 4.10E+01 | −5.96E+03 |
| 35 | 0 | 2.58E−01 | −2.10E+00 | 1.96E+01 | −3.36E+02 |
| 36 | 0 | −8.48E−02 | −8.37E−01 | −1.47E+01 | 2.69E+02 |

| Surface | a₁₀ | a₁₂ | a₁₄ | a₁₆ |
|---|---|---|---|---|
| 15 | 6.72E+00 | −5.17E+02 | 0.00E+00 | 0.00E+00 |
| 16 | −3.36E+02 | 2.31E+03 | 0.00E+00 | 0.00E+00 |
| 25 | 1.63E+04 | −1.20E+05 | 0.00E+00 | 0.00E+00 |
| 26 | 1.25E+05 | −7.62E+05 | 0.00E+00 | 0.00E+00 |
| 35 | 3.13E+03 | 7.72E+02 | −3.58E+05 | 2.27E+06 |
| 36 | −5.14E+03 | 2.96E+03 | 6.60E+05 | −5.49E+06 |

With reference to FIG. 3B to FIG. 3D, FIG. 3B illustrates a schematic graph of field curvature of a first sensing device 100S and a second sensing device 200S in this embodiment. FIG. 3C illustrates a schematic graph of distortion of the first sensing device 100S and the second sensing device 200S in this embodiment. FIG. 3D illustrates MTF curves of the first sensing device 100S and the second sensing device 200S in this embodiment.

As shown in FIG. 3B, when light with a wavelength of 940 nm is incident on the first sensing device 100S and the second sensing device 200S, the field curvature at different fields of view falls within the range of ±0.04 mm. The distortion aberration graph of FIG. 3C shows that the distortion aberration of the first sensing device 100S and the second sensing device 200S is maintained within the range of ±16%. As shown in FIG. 3D, when a spatial frequency is 27 lp/mm, its MTF is still greater than 0.75. With MTF above 30%, a resolution is 100 lp/mm.

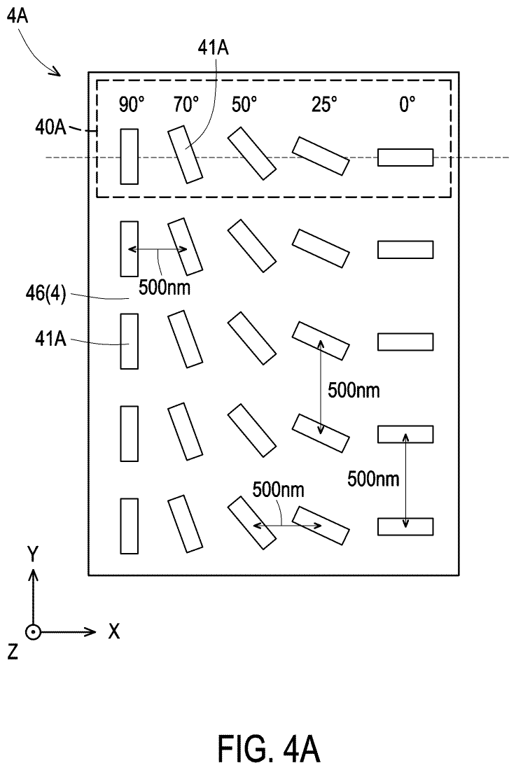

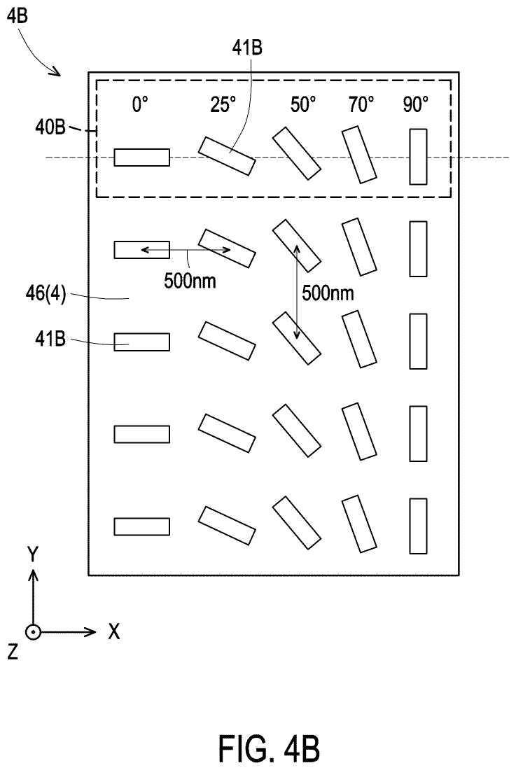

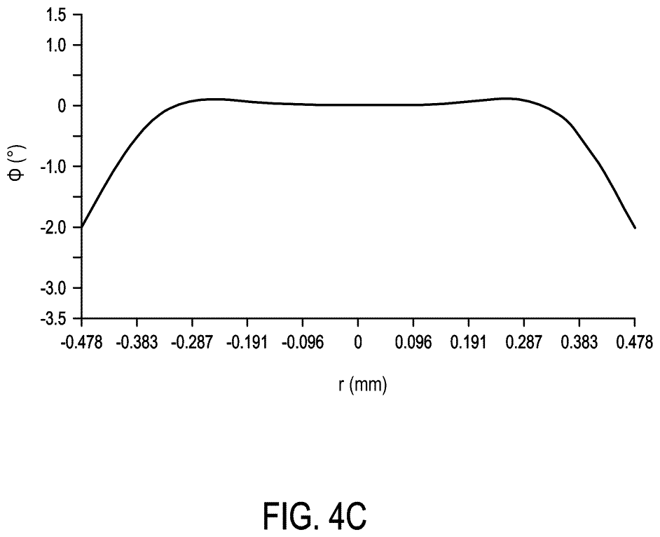

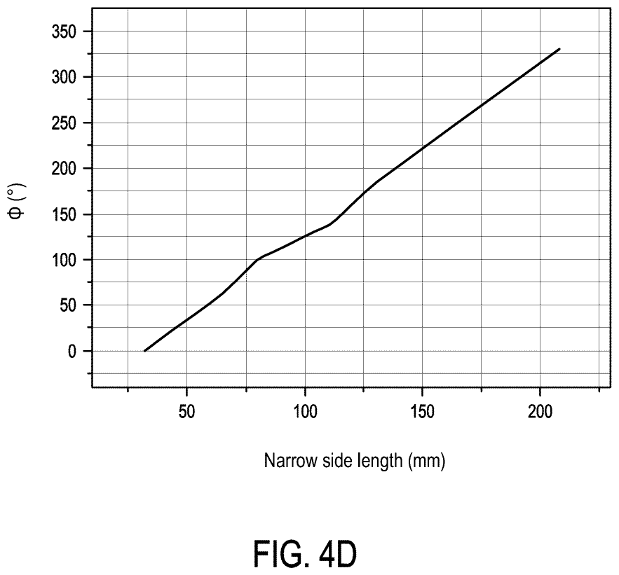

With reference to FIG. 2A, FIG. 3A, FIG. 4A, and FIG. 4B, a metal lens 4A disposed on an image-side surface 46 of a transparent substrate 4 of the first sensing device 100S includes a plurality of first nanostructures 41A, as shown in FIG. 4A. A metal lens 4B disposed on an image-side surface 46 of a transparent substrate 4 of the second sensing device 200S includes a plurality of second nanostructures 41B, as shown in FIG. 4B.

In the first sensing device 100S, these first nanostructures 41A of the metal lens 4A may be grouped into a plurality of groups 40A, and each group 40A includes five first nanostructures 41A. The five first nanostructures 41A of each group 40A are arranged in sequence in a negative X (−X) direction and have gradually larger angles with the negative X direction in sequence. As shown in FIG. 4A, the angles are 0 degrees, 25 degrees, 50 degrees, 70 degrees, and 90 degrees in sequence.

In the second sensing device 200S, these second nanostructures 41B of the metal lens 4B may be grouped into a plurality of groups 40B, and each group 40B includes five second nanostructures 41B. The five second nanostructures 41B of each group 40B are arranged in sequence in the negative X direction and have gradually smaller angles with the negative X direction in sequence. As shown in FIG. 4B, the angles are 90 degrees, 70 degrees, 50 degrees, 25 degrees, and 0 degrees in sequence.

It should be noted that the arrangement of the first nanostructures 41A is different from the arrangement of the second nanostructures 41B through the above. The metalens 4A and the metalens 4B may respectively transmit the first polarization state P1 and the second polarization state P2, so that the first sensing device 100S and the second sensing device 200S have measurement selectivity for light of different polarization states. The first sensing device 100S and the second sensing device 200S measure independently and do not interfere with each other. Compared to the approach of alternating the light-emitting time of different light sources through time sharing (i.e., reducing the frame rate) to prevent different sensing devices from interfering with each other as used in the related art, in the embodiments of the disclosure, the selectivity of measurement is achieved through arrangement of different metalenses without reducing the frame rate, the measurement time is shortened, and the accuracy of the depth sensing apparatus is also improved.

As shown in FIG. 4A and FIG. 4B, each of the first nanostructures 41A and the second nanostructures 41B has a non-circular symmetrical shape, such as a cuboid, and the cuboid has an example wide side length of 400 nm, an example narrow side length of 150 nm, and an example height of 700 nm. Herein, the wide side length and the narrow side length define the rectangles of the first nanostructures 41A and the second nanostructures 41B on a X-Y plane perpendicular to the optical axis I, and the wide side length is longer than the narrow side length. The height refers to sizes of the first nanostructures 41A and the second nanostructures 41B in a Z direction parallel to the optical axis I. There may be an example spacing of 500 nm between two adjacent first nanostructures 41A, but it is not limited thereto. There may be an example spacing of 500 nm between two adjacent second nanostructures 41B, but it is not limited thereto.

A phase delay distribution graph of the metalens 4A and the metalens 4B is shown in FIG. 4C. To be specific, FIG. 4C shows phase delays Φ caused by the metalens 4A and the metalens 4B on light with a wavelength of 940 nm. At the radius r=0 (that is, the position on the metalens 4A and metalens 4B that is passed by the optical axis I), the phase delay of the 940 nm light does not occur (as shown in FIG. 4C, Φ=0). As the radius r increases (that is, the position of the metalens 4A and the metalens 4B further away from the optical axis I), slightly different phase delays Φ occur, causing the metalens 4A and the metalens 4B to have negative diopter.

In order to achieve the phase delay shown in FIG. 4C, the metalens 4A and the metalens 4B need to configure the first nanostructures 41A and the second nanostructures 41B according to the graph shown in FIG. 4D. To be specific, in FIG. 4D, the horizontal axis represents the narrow side length of each of the first nanostructures 41A and the second nanostructures 41B, and the vertical axis represents the phase delays Φ caused by the first nanostructures 41A and the second nanostructures 41B to 940 nm light. In other words, different narrow side lengths cause different phase delays Φ. According to FIG. 4C, the phase delays Φ of the metal lens 4A and the metal lens 4B at different radii r in the region close to the optical axis I are approximately the same. This is because in this region, the first nanostructures 41A have approximately the same narrow side lengths, and similarly, in this region, the second nanostructures 41B have approximately the same narrow side lengths.

In the embodiments of the disclosure, the optical depth sensing apparatus measures the total time required for the first light beam to propagate from the first light source to the surface of the target to be measured, be reflected by the surface, and then enter the first sensing device, so as to calculate the distance to the target to be measured. It may be applied in one of the functions including depth sensing, identification, and obstacle avoidance. Further, the total time required for the second light beam to propagate from the second light source to the surface of the target to be measured, be reflected by the surface, and then enter the second sensing device is measured, so as to calculate the distance to the target to be measured. It may be applied in another one of the functions including depth sensing, identification, and obstacle avoidance. The first sensing device and the second sensing device have measurement selectivity for light of different polarization states, and the two can be measured independently without interfering with each other. Compared to the approach of alternating the light-emitting time of different light sources through time sharing (i.e., reducing the frame rate) to prevent different sensing devices from interfering with each other as used in the related art, in the embodiments of the disclosure, the selectivity of measurement is achieved through arrangement of different metalenses without reducing the frame rate, the measurement time is shortened, and the accuracy of the depth sensing apparatus is also improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An optical depth sensing apparatus, comprising:
a first light source configured to emit a first light beam having a first polarization state;
a second source configured to emit a second light beam having a second polarization state, wherein an electric field direction of the first polarization state is perpendicular to an electric field direction of the second polarization state;
a first sensing device configured to sense the first light beam and comprising a first metalens; and
a second sensing device configured to sense the second light beam and comprising a second metalens,
wherein the first light beam having the first polarization state is transmitted to the first metalens, and the second light beam having the second polarization state is reflected or absorbed by the first metalens,
wherein the second light beam having the second polarization state is transmitted to the second metalens, and the first light beam having the first polarization state is reflected or absorbed by the second metalens.

2. The optical depth sensing apparatus according to claim 1, wherein any one of the first sensing device and the second sensing device further comprises in sequence from an object side to an image side:
a first lens having negative optical power;
a second lens having negative optical power; and
a third lens having positive optical power,
wherein the corresponding first metalens or the second metalens is arranged between the third lens and an imaging surface.

3. The optical depth sensing apparatus according to claim 2, wherein the first metalens and the second metalens have negative diopter.

4. The optical depth sensing apparatus according to claim 3, wherein a field of view of the first sensing device and a field of view of the second sensing device fall within a range of 50 degrees to 70 degrees.

5. The optical depth sensing apparatus according to claim 3, wherein a distance on an optical axis from an object-side surface of the first lens to the imaging surface falls between 2.4 mm and 2.5 mm.

6. The optical depth sensing apparatus according to claim 3, wherein the first lens, the second lens, and the third lens are aspheric lenses.

7. The optical depth sensing apparatus according to claim 3, wherein the first sensing device and the second sensing device satisfy a conditional expression of 3.82<TTL/ImgH<7.2, wherein TTL is a distance on an optical axis from an object-side surface of the first lens to the imaging surface, and ImgH is half of a diagonal of the imaging surface.

8. The optical depth sensing apparatus according to claim 3, wherein an object-side surface of the first lens is a concave surface, and an image-side surface of the first lens is a convex surface.

9. The optical depth sensing apparatus according to claim 3, wherein an object-side surface of the second lens is a convex surface, and an image-side surface of the second lens is a concave surface.

10. The optical depth sensing apparatus according to claim 3, wherein an object-side surface of the third lens is a concave surface, and an image-side surface of the third lens is a convex surface.

11. The optical depth sensing apparatus according to claim 1, wherein the first metalens comprises a plurality of first nanostructures, the second metalens comprises a plurality of second nanostructures, and the first nanostructures and the second nanostructures have non-circular symmetrical shapes.

12. The optical depth sensing apparatus according to claim 11, wherein each of the non-circular symmetrical shape is a rectangle.

13. The optical depth sensing apparatus according to claim 11, wherein the first nanostructures are grouped into a plurality of first groups, the second nanostructures are grouped into a plurality of second groups, each of the first groups comprises five of the first nanostructures, and each of the second groups comprises five of the second nanostructures, wherein the five first nanostructures of each of the first groups are arranged in sequence in a first direction and have gradually larger angles with the first direction in sequence, and the five second nanostructures of each of the second groups are arranged in sequence in the first direction and have gradually smaller angles with the first direction in sequence.
